(19) United States
(12) Patent Application Publication
(10) Pub. No.: US 2026/0060321 A1
(43) Pub. Date: Mar. 5, 2026

(54) AEROSOL GENERATING DEVICE

(71) Applicant: KT&G CORPORATION, Daejeon (KR)

(72) Inventors: Chul Ho JANG, Bucheon-si (KR); Sang Cheol Park, Suwon-si (KR); Won Kyeong Lee, Guri-si (KR)

(73) Assignee: KT&G CORPORATION, Daejeon (KR)

(21) Appl. No.: 19/251,904

(22) Filed: Jun. 27, 2025

(30) Foreign Application Priority Data
Sep. 4, 2024 (KR) 10-2024-0120317

(51) Int. Cl. A24F 40/51; A24F 40/42; A24F 40/46; A24F 40/485; A24F 40/53; A24F 40/57; G01N 15/1031; G05D 23/24

(52) U.S. Cl. CPC A24F 40/51; A24F 40/42; A24F 40/46; A24F 40/485; A24F 40/53; A24F 40/57; G01N 15/1031; G05D 23/2401

(57) ABSTRACT

An aerosol generating device includes an aerosol generator configured to generate aerosols, and a potentiometric sensor configured to generate a signal based on an electric potential difference that changes according e to changes in components of aerosols generated by the aerosol generator.

### CROSS-REFERENCE TO RELATED APPLICATION

This application is based on and claims priority under 35 U.S.C. § 119 to Korean Patent Application No. 10-2024-0120317, filed on Sep. 4, 2024, in the Korean Intellectual Property Office, the disclosure of which is incorporated by reference herein in its entirety.

### BACKGROUND

### 1. Field

Embodiments relate to an aerosol generating device, and more particularly, to an aerosol generating device capable of precisely detecting changes in components of aerosols.

### 2. Description of the Related Art

Recently, there has been an increasing demand for an alternative method of overcoming the disadvantages of normal cigarettes. For example, there is an increasing demand for a system for generating aerosols by heating an aerosol generating substrate by using an aerosol generating device, rather than by burning cigarettes.

Aerosol generating devices may include sensors for controlling operations of the aerosol generating devices. For example, an aerosol generating device including a temperature sensor may be configured to sense a change in temperature of a heater or around the heater. As another example, when an aerosol generating device includes a puff sensor for sensing a puff action of a user, operations of the aerosol generating device may be controlled based on a puff action of the user inhaling an aerosol.

### SUMMARY

An aerosol generating device including a temperature sensor or a puff sensor may be configured to use signal information related to a temperature or a puff operation by a user with reference to operations of the aerosol generating device. However, the signal information related to the temperature or the puff operation by the user is not directly related to ingredients included in aerosols generated by the aerosol generating device and delivered to the user.

It is important that the aerosol generating device efficiently operates in correspondence to various environments in which the aerosol generating device is used and various types of users using the aerosol generating device. An aerosol generating device capable of sensing ingredients included in the aerosols is required for efficient operations of the aerosol generating device.

Embodiments provide an aerosol generating device that may operate based on signal information directly related to ingredients of aerosols of the aerosol generating device.

Technical goals to be achieved through embodiments are not limited thereto, and technical goals unmentioned above would be clearly understood to those skilled in the art based on the present specification and the accompanying drawings.

Additional aspects will be set forth in part in the description which follows and, in part, will be apparent from the description, or may be learned by practice of the presented embodiments of the disclosure.

According to an embodiment, an aerosol generating device include an aerosol generator configured to generate aerosols; and a potentiometric sensor configured to generate a signal based on an electric potential difference that changes according to changes in components of the aerosols generated by the aerosol generator.

The aerosol generating device may further include a path through which at least a portion of the aerosols generated in the aerosol generator flows. The potentiometric sensor may be configured to generate the signal, based on changes in components of the aerosols flowing through the path.

At least a portion of the potentiometric sensor may be located on the path.

The potentiometric sensor may be configured to generate the signal, based on a pH change in the aerosols.

The aerosol generator may include an aerosol generating chamber for generating the aerosols. The path may be connected to the aerosol generating chamber, the aerosols generated in the aerosol generating chamber may flow through the path.

The potentiometric sensor may generate the signal, based on changes in components of the aerosols flowing through the path.

The aerosol generator may include an accommodating portion for accommodating an aerosol generating article for generating aerosols.

The aerosol generator may further include a heater configured to heat the aerosol generating article.

The path may be formed by a space between the aerosol generating article accommodated in the accommodating portion and an inner surface of the accommodating portion.

The aerosol generator may include an accommodating portion for accommodating an aerosol generating article for generating aerosols; and a heater configured to heat the aerosol generating article. The path may pass through the accommodating portion.

The aerosol generator may include a cartridge configured to generate aerosols from an aerosol generating article. The aerosol generator may further include an accommodating portion accommodating the aerosol generating article and configured to deliver the aerosols generated in the cartridge to the aerosol generating article.

The potentiometric sensor may be arranged in the accommodating portion.

The aerosol generator may further include a heater configured to generate aerosols by heating the aerosol generating article accommodated in the accommodating portion.

The potentiometric sensor may be configured to generate a signal based on an electric potential difference that changes according to changes in components of at least one of the aerosols generated from the aerosol generating article and the aerosols generated in the cartridge.

The aerosol generating device may further include a controller configured to control operation of the aerosol generator.

The aerosol generator may be configured to generate aerosols from an aerosol generating material.

The controller may be configured to detect exhaustion of the aerosol generating material, based on the signal of the potentiometric sensor. The controller may stop operation of the aerosol generator when the aerosol generating material is exhausted.

The controller may be configured to sense abnormal operation of the aerosol generator, based on the signal of the potentiometric sensor. The controller may stop the operation of the aerosol generator when the aerosol generator is in the abnormal operation.

The aerosol generator may include a heater configured to generate aerosols.

The aerosol generating device may further include a controller configured to control operation of the heater, based on a preset temperature profile.

The controller may be configured to change the temperature profile to control the operation of the heater, based on the signal of the potentiometric sensor.

The potentiometric sensor may include a signal generator formed of a mesh material through which aerosols pass.

Droplets may be generated when aerosols pass through the signal generator. The signal generator may be configured to generate the signal based on changes in the electric potential difference according to changes in components of the droplets.

The potentiometric sensor may come into contact with the aerosols and liquefy a portion of the aerosols. The potentiometric sensor may generate the signal upon contact with droplets generated from the aerosols.

The potentiometric sensor may include a reference electrode and a measuring electrode. The signal may be generated in accordance with changes in an electric potential difference between the reference electrode and the measuring electrode according to changes in components of the aerosols.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2A illustrates an aerosol generating device according to another embodiment;

FIG. 2B illustrates an aerosol generating device according to another embodiment;

FIG. 3 illustrates an aerosol generating device according to another embodiment;

FIG. 4 illustrates an aerosol generating device according to another embodiment;

FIG. 5 is a cross-sectional view in a longitudinal direction of an aerosol generating device according to another embodiment;

FIG. 6 is a cross-sectional view in a longitudinal direction of a portion of an aerosol generating device according to another embodiment;

FIG. 7 is a cross-sectional view of an aerosol generating device according to another embodiment;

FIG. 8 is a cross-sectional view of an aerosol generating device according to another embodiment;

FIG. 9 is a cross-sectional view of an aerosol generating device according to another embodiment;

FIG. 10 is a perspective view of a potentiometric sensor applicable to the aerosol generating device according to the embodiments illustrated in FIGS. 1 to 9;

FIG. 11 is a flowchart illustrating an example of operation of an aerosol generating device according to various embodiments;

FIG. 12 is a flowchart illustrating another example of operation of an aerosol generating device according to various embodiments; and

FIG. 13 is a flowchart illustrating another example of operation of an aerosol generating device according to various embodiments.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

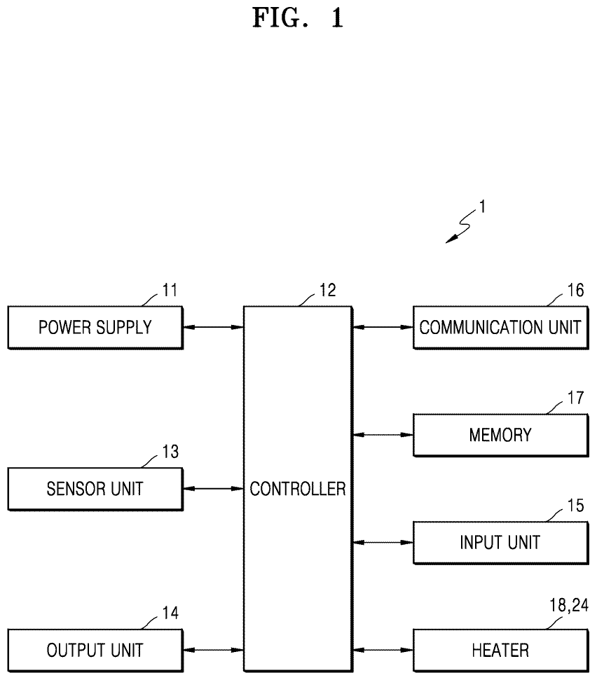

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1.

That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article. For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article of the present disclosure may contain at least one aerosol-generating rod (e.g., medium portion) and at least one filter rod. The heater 18 may arranged to correspond to the at least one aerosol generating rod and may be designed variously according to arrangement order and/or positions of the aerosol generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

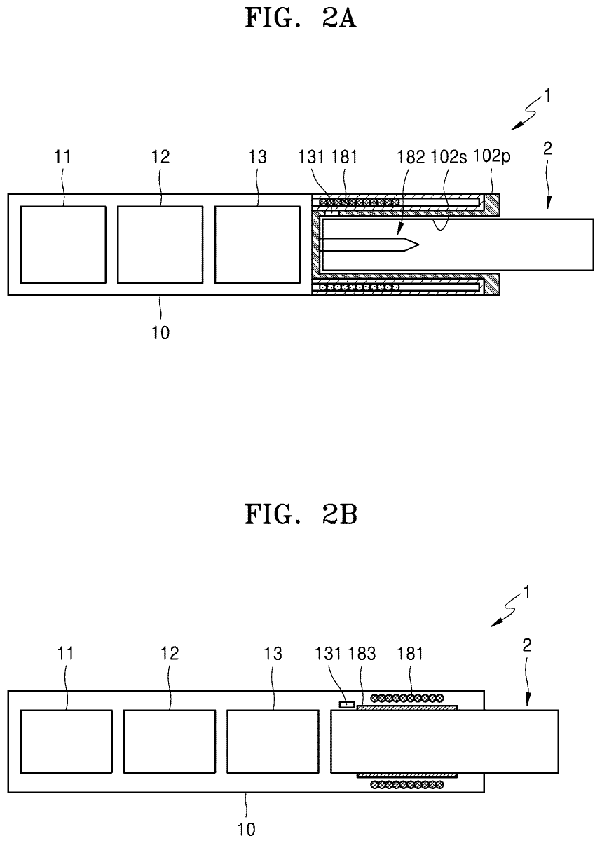

FIG. 2A illustrates an aerosol generating device 1 according to another embodiment. FIG. 2B illustrates an aerosol generating device 1 according to another embodiment.

According to the embodiments illustrated in FIGS. 2A and 2B, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2A or FIG. 2B and that some of the components may be omitted or new components may be further included. The aerosol-generating device 1 shown in FIG. 2A may be referred to as an “internal heating-type” aerosol-generating device that heats the inner side of an aerosol-generating article 2. The aerosol-generating device 1 shown in FIG. 2B may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2A, the heater 182 may include an internal-heating type heater.

The heater 182 is an example of an aerosol generator for generating an aerosol from the aerosol generating article 2. The aerosol generator may include a receiving portion 102p including an insertion space for accommodating the aerosol generating article 2, and a heater 182 arranged in the receiving portion 102p to generate heat for heating the aerosol generating article 2.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

The aerosol generating device 1 includes a potentiometric sensor 131 configured to generate a signal according to a change in ingredients of the aerosols generated by the heater 182, i.e., the aerosol generator. The potentiometric sensor 131 may be arranged outside the aerosol generating article 2. The potentiometric sensor 131 is arranged adjacent to an end portion of the aerosol generating article 2 accommodated in the accommodating portion 102p.

A path may be formed by a space between the aerosol generating article 2 accommodated in the accommodating portion 102p and an inner surface 102s of the accommodating portion 102p. The aerosols generated in the aerosol generator may flow along at least a section of the path.

The potentiometric sensor 131 may be configured to detect a change in the ingredients of the aerosols flowing through the path. The potentiometric sensor 131 may be configured to generate a signal as an electric potential difference changes due to the change in the ingredients of the aerosols generated from the aerosol generating article 2 heated by the heater 182.

The ingredients to be detected by the potentiometric sensor 131 may include, for example, nicotine or a pH concentration (a hydrogen ion concentration) of droplets included in the aerosols.

Referring to FIG. 2B, the heater 183 may be an external heating-type heater.

The heater 183 is another example of an aerosol generator for generating an aerosol from the aerosol generating article 2.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2A will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2A or FIG. 2B, both the heater 182 in FIG. 2A and the heater 183 in FIG. 2B may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

The aerosol generating device 1 includes the potentiometric sensor 131 configured to generate a signal according to a change in the ingredients of the aerosols generated by the heater 183, i.e., the aerosol generator. The potentiometric sensor 131 may be arranged outside the aerosol generating article 2. The potentiometric sensor 131 is arranged adjacent to the end portion of the aerosol generating article 2 accommodated in the aerosol generating device 2.

A path may be formed in a space outside the aerosol generating article 2. The aerosols generated in the aerosol generator may flow along at least a section of the path.

The potentiometric sensor 131 may be configured to detect the change in the ingredients of the aerosols flowing through the path. The potentiometric sensor 131 may be configured to generate a signal as an electric potential difference changes due to a change in the ingredients of the aerosols generated from the aerosol generating article 2 heated by the heater 182.

The ingredients to be detected by the potentiometric sensor 131 may include, for example, nicotine or the pH concentration (the hydrogen ion concentration) of droplets included in the aerosols.

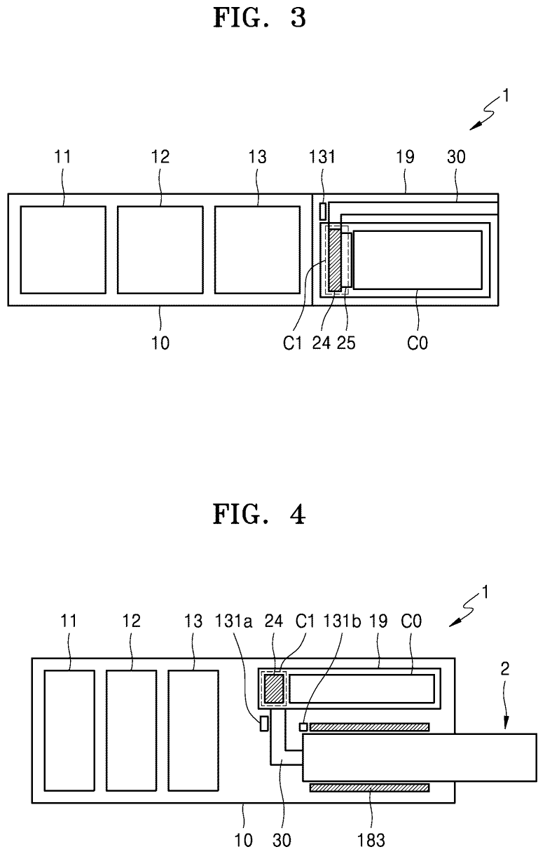

FIG. 3 shows an aerosol-generating device 1 according to an embodiment. According to one embodiment, the aerosol-generating device 1 may include a housing 10, a power supply 11, a controller 12, and/or a sensor unit 13. However, it will be understood by those skilled in the art related to the present embodiment that the components included in the aerosol-generating device 1 are not limited to those shown in FIG. 3 and that some of the components may be omitted or new components may be further included. In the drawings below, a description of configurations identical to those shown in FIG. 1 will be omitted.

According to one embodiment, the housing 10 may include a structure that allows a cartridge 19 to be inserted into or mounted on one side thereof. In this case, the cartridge 19 may be removably coupled to the housing 10.

Although not shown in the drawings, the housing 10 and/or the cartridge 19 may include a mouthpiece. A user may inhale an aerosol while holding the mouthpiece in the mouth.

According to one embodiment, the cartridge 19 may include a chamber C0 containing an aerosol-generating substance. The chamber C0 may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance.

According to one embodiment, a liquid delivery part 25 that is impregnated with (contains) the aerosol-generating substance may be included in the cartridge 19. For example, the liquid delivery part 25 may be impregnated with the aerosol-generating substance supplied from the chamber C0. Here, the liquid delivery part 25 may include a wick formed of, e.g., cotton fiber, ceramic fiber, glass fiber, or porous ceramic. Although not shown in the drawings, the aerosol-generating device 1 may further include a liquid delivery part. In this case, at least a portion of the first liquid delivery part of the cartridge 19 and at least a portion of the second liquid delivery part of the aerosol-generating device 1 may be formed in contact with each other. In this case, the first liquid delivery part and the second liquid delivery part may be implemented in different forms. For example, the first liquid delivery part may include cotton fiber, and the second liquid delivery part may include porous ceramic. Alternatively, the cartridge 19 may not include a liquid delivery part, and the aerosol-generating substance in the cartridge 19 may be delivered to the liquid delivery part of the aerosol-generating device 1.

According to one embodiment, the housing 10 and/or the cartridge 19 may be provided with an airflow channel through which air flows.

For example, the housing 10 may include a structure allowing outside air to be introduced into the housing 10 in the state in which the cartridge 19 is coupled thereto. In an example, an air inlet through which outside air may be introduced into the housing 10 may be formed in one side surface of the housing 10. The air inlet may also be formed in the lower end surface of the housing 10. Outside air introduced into the housing 10 through the air inlet may pass through the cartridge 19, and then may flow toward the user's oral cavity through the passage 30. The outside air introduced through the air inlet may flow to the user's oral cavity through the passage 30 via the cartridge 19.

For example, the passage 30 may be included in the cartridge 19. The passage 30 may connect the chamber (e.g., an atomization chamber) in which the cartridge heater 24 or the liquid delivery part 25 is disposed to the outside of the housing 10 and/or the cartridge 19. In more detail, one end of the passage 30 may be open to the chamber (e.g., the atomization chamber) in which the cartridge heater 24 or the liquid delivery part 25 is disposed, and the other end thereof may communicate with the mouthpiece. The passage 30 may be elongated from one side of the chamber C0 of the cartridge 19 in the longitudinal direction of the cartridge 19. The passage 30 may also be elongated in the longitudinal direction of the cartridge 19 through the chamber C0 of the cartridge 19. The passage 30 may also communicate with a separate mouthpiece provided at the housing 10.

According to one embodiment, the cartridge heater 24 may heat the aerosol-generating substance contained in the cartridge 19. For example, the cartridge heater 24 may include an electro-resistive heater and/or an induction heater. In an example, the electro-resistive heater may include an electro-resistive material, and may generate heat as current flows through the electro-resistive material. In another example, in the case of an induction heater, the aerosol-generating device 1 may include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part included in the cartridge 19 and/or the aerosol-generating device 1 and/or in a shape (e.g., a pattern shape) contacting one side of the liquid delivery part.

According to one embodiment, the cartridge heater 24 may be included in the cartridge 19. If the cartridge 19 is formed to be removable from the housing 10, the cartridge heater 24 may be removed from the aerosol-generating device 1 together with the cartridge 19. Unlike the configuration shown in the drawings, the cartridge heater 24 may be included in the aerosol-generating device 1. For example, the cartridge heater 24 may be included inside the housing 10. Meanwhile, the cartridge heater 24 may be included in a form that is removable from the housing 10 separately from (i.e., independently of) the cartridge 19. In other words, the cartridge heater 24 may or may not be removed from the housing 10 regardless of removal of the cartridge 19.

According to one embodiment, an aerosol may be generated based on generation of heat by the cartridge heater 24. As the liquid delivery part 25 is heated by the cartridge heater 24, an aerosol may be generated. For example, as the aerosol-generating substance impregnated in the liquid delivery part 25 is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be inhaled into the user's oral cavity through the passage 30.

According to one embodiment, the cartridge 19 may be integrally formed with the aerosol-generating device 1 (e.g., the housing 10). The cartridge 19 may be formed so as not to be removed from the aerosol-generating device 1 by the user. Even in this case, the cartridge 19 and/or the aerosol-generating device 1 may include at least one liquid delivery part, and an aerosol may be generated based on heating of the liquid delivery part 25 by the cartridge heater 24 included in the aerosol-generating device 1 or the cartridge 19. The generated aerosol may be inhaled into the user's oral cavity through the passage 30.

The cartridge heater 24 and the liquid delivery element 25 are other examples of the aerosol generator. The aerosol generator 1 may include an aerosol generating chamber C1 for generating aerosols. At least one of the cartridge heater 24 and the liquid delivery element 25 may be in the aerosol generating chamber C1.

The aerosol generating device 1 includes the path 30. The path 30 may extend in a longitudinal direction of the aerosol generating device 1. One end of the path 30 is connected to the aerosol generating chamber C1, and the other end of the path 30 is open outward. The aerosols generated in the aerosol generator may be discharged outside through the path 30.

The aerosol generating device 1 includes the potentiometric sensor 131 configured to generate a signal according to a change in the ingredients of the aerosols generated by the cartridge heater 24. At least a portion of the potentiometric sensor 131 may be arranged in the path 30.

The aerosols generated in the aerosol generator may flow through the path 30. The potentiometric sensor 131 may be configured to detect a change in the ingredients of the aerosols flowing through the path 30. The potentiometric sensor 131 may be configured to generate the signal as the electric potential difference changes due to a change in the ingredients of the aerosols generated in the aerosol generating chamber C1.

The ingredient of the aerosols to be detected by the potentiometric sensor 131 may include nicotine or a pH concentration of droplets included in the aerosols.

FIG. 4 illustrates the aerosol generating device 1 according to another embodiment.

According to one embodiment, the aerosol-generating device 1 may include a housing 10, a power supply 11, a controller 12, a sensor unit 13, and/or a heater 183 and 24 (e.g., the heater 18 and 24 in FIG. 1). However, it will be understood by those skilled in the art related to the present embodiment that the components included in the aerosol-generating device 1 are not limited to those shown in FIG. 4 and that some of the components may be omitted or new components may be further included. In the drawings below, a description of configurations identical to those shown in FIG. 1 will be omitted.

According to one embodiment, the housing 10 may provide a space that is open upwardly to allow the aerosol-generating article 2 to be inserted thereinto (hereinafter referred to as an insertion space). The insertion space may be formed so as to be depressed in the housing 10 to a predetermined depth so that at least a portion of the aerosol-generating article 2 may be inserted thereinto. The lower end of the aerosol-generating article 2 may be inserted into the housing 10, and the upper end of the aerosol-generating article 2 may protrude outside the housing 10.

Unlike the configuration shown in the drawings, the cartridge 19 may provide an insertion space for receiving the aerosol-generating article 2. In this case, the insertion space may be formed so as to be depressed in the cartridge 19 to a predetermined depth so that at least a portion of the aerosol-generating article 2 may be inserted thereinto. The lower end of the aerosol-generating article 2 may be inserted into the cartridge 19, and the upper end of the aerosol-generating article 2 may protrude outside the cartridge 19. In this case, the aerosol-generating device 1 may not include the heater 183.

According to one embodiment, the depth of the insertion space may be equal to or greater than the length of a region of the aerosol-generating article 2 in which an aerosol-generating substance and/or a medium is contained. A user may inhale air while holding the externally exposed upper end of the aerosol-generating article 2 in the mouth.

According to one embodiment, the heater 183 may heat the aerosol-generating article 2. The heater 183 may be elongated upwardly around the space into which the aerosol-generating article 2 is inserted (i.e., the insertion space). In an example, the heater 183 may have a tube shape (e.g., a cylindrical shape) with a cavity formed therein. The heater 183 may include a shape including a cavity formed therein and surrounding the cavity. In this case, the heater 183 may be supported by a polyimide film. The heater supported by this film may be referred to as a film heater. The heater 183 may be disposed so as to surround at least a portion of the insertion space. The heater 183 may heat the outer side of the aerosol-generating article 2 inserted into the cavity. In the present disclosure, the heater 183 may be referred to as an external heating-type heater, which heats the outer side of the aerosol-generating article 2. Meanwhile, a thermally insulating material may be disposed outside the heater 183. Accordingly, the amount of heat emitted from the heater 183 in the radially outward direction and released outside the housing 10 may be reduced.

According to one embodiment, the heater 183 may include an electro-resistive heater and/or an induction heater.

For example, the electro-resistive heater may include an electro-resistive material, and may generate heat as current flows through the electro-resistive material. In this case, the electro-resistive heater may be electrically connected to the power supply 11, and may directly generate heat using current received from the power supply 11.

For example, in the case of an induction heater, the aerosol-generating device 1 may further include an induction coil (not shown) surrounding at least a portion of the heater 183 (e.g., disposed outside the heater 183 so as to correspond to the length of at least a portion of the heater 183). In this case, a magnetic flux concentrator may be further provided outside the induction coil (not shown) in order to increase efficiency of induction heating. The induction heater may include a susceptor, and may generate heat based on a magnetic field generated by the induction coil (not shown).

According to one embodiment, the heater 183 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 183 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively. In addition, three or more heaters and/or three or more induction coils may be included.

Unlike the configuration shown in the drawings, the aerosol-generating device 1 may not include the heater 183. The aerosol-generating article 2 may be directly or indirectly heated by the cartridge heater 24 or may not be substantially heated. Indirect heating may mean that the aerosol-generating article 2 is heated by receiving heat contained in the aerosol during the process in which the aerosol generated by the cartridge heater 24 passes through the aerosol-generating article 2. In this case, the aerosol-generating device 1 may be referred to as a non-heating-type (or indirect heating-type) aerosol-generating device. An additive such as an alkaline substance may be contained in the aerosol-generating rod of the aerosol-generating article 2. Based on the alkaline substance, nicotine contained in the aerosol-generating rod may have an alkaline pH (e.g., pH 7.0 or higher). This alkaline nicotine may flow to the user's oral cavity together with the aerosol introduced into the aerosol-generating article 2 from the cartridge 19 to be described later.

Unlike the configuration shown in the drawings, the heater 183 may include an internal heating-type heater. For example, the internal heating-type heater may include various heating elements, such as a rod-shaped heating element, a tubular heating element, a plate-shaped heating element, or a needle-shaped heating element. The internal heating-type heater may be inserted through the lower portion of the aerosol-generating article 2, and may be set to heat the inner side of the aerosol-generating article 2.

According to one embodiment, the cartridge 19 may be removably coupled to the housing 10. For example, a space may be formed in one side of the housing 10, and at least a portion of the cartridge 19 may be inserted into the space formed in one side of the housing 10 so that the cartridge 19 is mounted to the housing 10. Alternatively, the cartridge 19 may be integrally formed with the housing 10.

According to one embodiment, the aerosol-generating device 1 and/or the cartridge 19 may be provided with an airflow channel through which air flows. For example, the housing 10 may include a structure allowing outside air to be introduced into the housing 10 in the state in which the cartridge 19 is inserted thereinto. The introduced air may pass through the cartridge 19, may be introduced into the insertion space through the passage 30, and then may flow to the user's oral cavity. The passage 30 may include various structures for reducing residual droplets or making the flow of air smooth.

Although it is illustrated in FIG. 4 that the cartridge 19 is located beside the aerosol-generating article 2 and the passage 30 is formed from the side surface of the aerosol-generating article 2 to the lower end (i.e., upstream side) of the aerosol-generating article 2, the positions of the cartridge 19 and the passage 30 are not limited thereto. For example, the cartridge 19 may be located adjacent to the lower end (i.e., upstream side) of the aerosol-generating article 2. In this case, the passage 30 may be formed in a substantially straight shape to connect the cartridge 19 to the lower end (i.e., upstream side) of the aerosol-generating article 2.

According to one embodiment, the cartridge 19 may include a storage part C0 that contains an aerosol-generating substance, a cartridge heater 24, and/or a liquid delivery part that is impregnated with (contains) the aerosol-generating substance. The liquid delivery part 25 may be impregnated with the aerosol-generating substance supplied from the chamber C0. For example, the liquid delivery part may include a wick formed of, e.g., cotton fiber, ceramic fiber, glass fiber, or porous ceramic.

According to one embodiment, the cartridge heater 24 may heat the aerosol-generating substance contained in the cartridge 19. For example, the cartridge heater 24 may include an electro-resistive heater and/or an induction heater.

In an example, the electro-resistive heater may include an electro-resistive material, and may generate heat as current flows through the electro-resistive material. In another example, in the case of an induction heater, the aerosol-generating device 1 may further include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part and/or in a shape (e.g., a patterned shape) contacting one side of the liquid delivery part.

Unlike the configuration shown in the drawings, the cartridge heater 24 may be included in the aerosol-generating device 1. For example, the cartridge heater 24 may be included inside the housing 10. In this case, the cartridge 19 and the cartridge heater 24 may be separated by removal of the cartridge 19.

According to one embodiment, an aerosol may be generated based on generation of heat by the cartridge heater 24. For example, as the aerosol-generating substance impregnated in the liquid delivery part is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be introduced into the aerosol-generating article 2 through the passage 30. While the aerosol passes through the aerosol-generating article 2, tobacco or a flavoring substance may be added to the aerosol, and the aerosol containing the tobacco or the flavoring substance may be inhaled into the user's oral cavity through one end of the aerosol-generating article 2.

The cartridge heater 24 may be an example of the aerosol generator. The aerosols generated by the cartridge heater 24 may flow through the path 30. The aerosol generating device 1 includes a potentiometric sensor 131a configured to generate a signal according to a change in the ingredients of the aerosols generated by the cartridge heater 24.

The potentiometric sensor 131a may be configured to detect the change in the ingredients of the aerosols flowing through the path 30. The potentiometric sensor 131a may be configured to generate the signal as the electric potential difference changes due to the change in the ingredients of the aerosols generated by the cartridge heater 24.

The heater 183 may be another example of the aerosol generator. The aerosols may be heated by the aerosol generating article 2 by the heater 183.

The aerosol generating device 1 includes a potentiometric sensor 131b configured to generate a signal according to a change in the ingredients of the aerosol generated from the aerosol generating article 2 heated by the heater 183.

The potentiometric sensor 131b may be arranged outside the aerosol generating article 2. The potentiometric sensor 131b is arranged adjacent to the end portion of the aerosol generating article 2 accommodated in the aerosol generating device 1.

An additional path 30 may be formed in a space outside the aerosol generating article 2. The aerosols generated from the aerosol generating article 2 may flow along at least a section of the additional path. For example, when the user holds the aerosol generating article 2 by mouth and inhales, a flow of mainstream smoke of the aerosols penetrating the aerosol generating article 2 may be generated, and a flow of second-hand smoke of the aerosols flowing along the external surface of the aerosol generating article 2 may be generated.

The potentiometric sensor 131b may be configured to detect the change in the ingredients of the aerosols flowing through the additional path on the external surface of the aerosol generating article 2. The potentiometric sensor 131 may be configured to generate a signal as an electric potential difference changes due to a change in the ingredients of the aerosols generated from the aerosol generating article 2 heated by the heater 182.

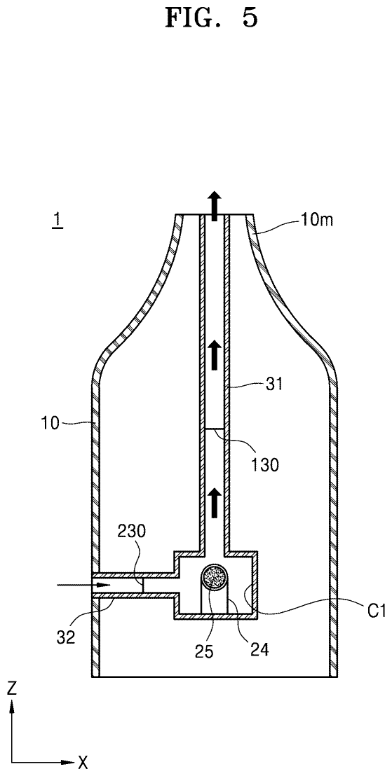

FIG. 5 is a cross-sectional view in a longitudinal direction of the aerosol generating device 1 according to another embodiment.

The aerosol generating device 1 with reference to the embodiment illustrated in FIG. 5 includes an aerosol generator for generating aerosols and the potentiometric sensor 130 configured to generate a signal based on an electric potential difference that changes according to changes in components of the aerosols generated in the aerosol generator.

The aerosol generator includes the aerosol generating chamber C1 in which the aerosols are generated, the liquid delivery element 25 in the aerosol generating chamber C1, and the cartridge heater 24 configured to generate the aerosols by heating the liquid delivery element 25.

The aerosol generating device 1 includes a path 31 for discharging the aerosols generated in the aerosol generator to the outside. The potentiometric sensor 130 is arranged in the path 31.

The aerosol generating device 1 may include a supply path 32 for supplying air to the aerosol generator and an upstream potentiometric sensor 230 configured to generate a signal based on an electric potential difference that changes according to changes in components of the aerosols generated in the aerosol generator.

Air introduced from the outside of the housing 10 into the aerosol generating device 1 flows through the supply path 32 and then is introduced into the aerosol generating chamber C1. The aerosols generated in the aerosol generating chamber C1 of the aerosol generator may fill the aerosol generating chamber C1. Even before an inhalation operation is performed by the user, at least a portion of the aerosols filling the aerosol generating chamber C1 may flow through the path 31 and the supply path 32.

When the user performs the inhalation operation, the aerosols generated in the aerosol generating chamber C1 may flow through the path 31 of the aerosol generator and then be discharged outward. The user may hold a mouthpiece 10m provided at an end of the aerosol generator, by mouth, and inhale the aerosols.

As the aerosol generator operates, the ingredients included in the aerosol may change. The potentiometric sensor 130 and the upstream potentiometric sensor 230 may be configured to detect the change in the ingredients of the aerosols. For example, as electric potential differences of the potentiometric sensor 130 and the upstream potentiometric sensor 230 change according to the pH concentration of the aerosols, signals of the potentiometric sensor 130 and the upstream potentiometric sensor 230 may be generated.

Each of the potentiometric sensor 130 and the upstream potentiometric sensor 230 may include a reference electrode and a measuring electrode. For example, the reference electrode and the measuring electrode may be manufactured by using any one of a sensing material such as silver chloride or potassium chloride, a glass electrode, indium tin oxide (ITO), or an Ion Sensitive Field Effect Transistor (ISFET), or a combination thereof.

In addition, each of the potentiometric sensor 130 and the upstream potentiometric sensor 230 may further include a protective material or a coating material manufactured by using any one of polycarbonate (PC), polyimide (PI), polyetherimide, or polytetrafluoroethylene (PTFE), or a combination thereof.

When each of the potentiometric sensor 130 and the upstream potentiometric sensor 230 is in contact with the aerosols, droplets may be generated on a surface of each of the potentiometric sensor 130 and the upstream potentiometric sensor 230. For generation of the droplets, the surface of each of the potentiometric sensor 130 and the upstream potentiometric sensor 230 may be maintained at a temperature lower than a temperature of the aerosols.

A change in the ingredients of the droplets attached to the surface of each of the potentiometric sensor 130 and the upstream potentiometric sensor may cause an electric potential difference between electric signals of the reference electrode and the measuring electrode. Each of the potentiometric sensor 130 and the upstream potentiometric sensor 230 may be configured to generate a signal according to a change in the electric potential difference between the reference electrode and the measuring electrode. The pH concentration may be detected based on the signal of each of the potentiometric sensor 130 and the upstream potentiometric sensor 230.

Each of the potentiometric sensor 130 and the upstream potentiometric sensor 230 may further include any one of a detecting circuit for detecting the generated signal or an amplifying circuit for amplifying the signal detected by the detecting circuit, or a combination thereof.

According to the aerosol generating device 1 with reference to the embodiment described above, as the electric potential difference of each of the potentiometric sensor 130 and the upstream potentiometric sensor 230 changes due to the change in the ingredients of the aerosols, the signal of each of the potentiometric sensor 130 and the upstream potentiometric sensor 230 is generated. Accordingly, the change in the ingredients of the aerosols generated in the aerosol generating device 1 may be precisely and rapidly detected.

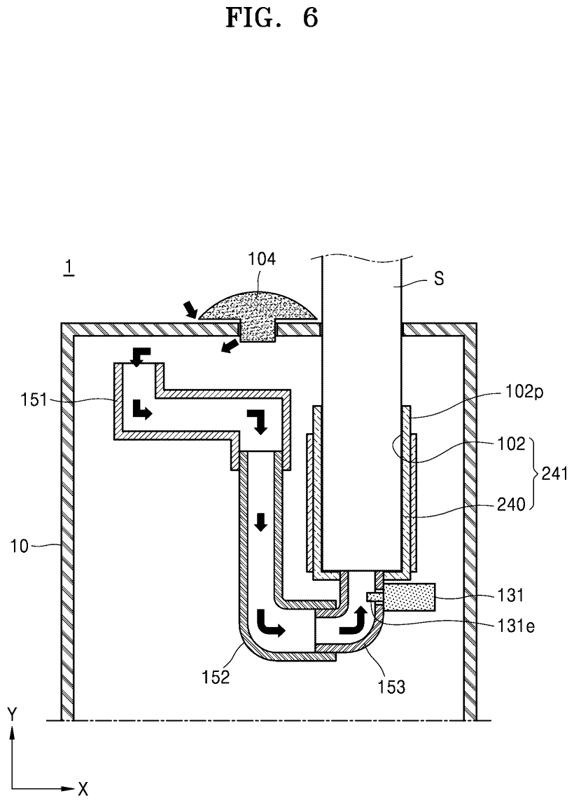

FIG. 6 is a cross-sectional view in a longitudinal direction of a portion of the aerosol generating device 1 according to another embodiment.

The aerosol generating device 1 reference to the embodiment in FIG. 6 includes an aerosol generator 241 for generating aerosols and the potentiometric sensor 131 for generating the signal based on an electric potential difference that changes according to changes in components of the aerosols generated in the aerosol generator 241. The aerosol generating device 1 may include paths 151, 152, and 153 for supplying external air to the aerosol generator 241.

Elements such as the aerosol generator 241, the paths 151, 152, and 153, and the potentiometric sensor 131 may be arranged in the housing 10. When a cover 104 moves with respect to the housing 10 and thus a portion of the housing 10 is open, a portion of a stick S is inserted into the housing 10, and another portion of the stick S is exposed outside the housing 10.

The aerosol generator 241 includes the accommodating portion 102p including an insertion portion 102 and a heater 240 arranged in the accommodating portion 102p and configured to generate heat for heating the stick S.

The stick S is heated by the heater and generates the aerosols. The stick S may be referred to as a cigarette. The stick S is an example of the aerosol generating article.

‘Aerosols’ may indicate gas generated by mixture of air and vapor generated by heating the aerosol generating material or mixture of air and liquid particles having a fine size atomized from the aerosol generating device.

The embodiments are not limited to a method of generating the aerosols by heating the stick S of the aerosol generator 241 illustrated in FIG. 6. The aerosol generator 241 may be configured to, for example, generate the aerosols by using the heater being inserted into the stick S and generating heat, generate the aerosols by heating the aerosol generating material in a liquid state, or generate the aerosols from the aerosol generating material in the liquid state through ultrasonic vibration.

The user may inhale the aerosols in a state of holding, by mouth, the stick S protruding outside the housing 10. An operation of inhaling by the user in a state of holding the stick S by the mouth may be referred to as ‘puff operation’. Performance of the puff operation causes air flow through the stick S, and thus, the aerosol generated from the stick S may be delivered to the user.

While the puff operation is performed, external air may be supplied to the stick S. A state where the portion of the stick S is inserted into the housing 10, as illustrated in FIG. 6, corresponds to a state where a portion of the housing 10 is open by the cover 104. Air outside the housing 10 may be introduced into the housing 10 through a gap between the cover 104 and the housing 10.

The paths 151, 152, and 153 are connected in a fluidal manner to the insertion space 102 of the accommodating portion 102p through an introducing path 151, an intermediate path 152, and a supply path 153, wherein the external air may be introduced into the housing 10. Air outside the housing 10 may sequentially pass through the introducing path 151, the intermediate path 152, and the supply path 153.

The potentiometric sensor 131 may be arranged on the supply path 153. An electrode 131e of the potentiometric sensor 131 may protrude toward the supply path 153. The potentiometric sensor 131 may be configured to detect a change in the ingredients of the aerosols generated in the aerosol generator 241. As the electric potential difference of the potentiometric sensor 131 changes due to the change in the ingredients of the aerosols generated from the stick S heated by the heater 182, the potentiometric sensor 131 may generate a signal.

For example, the ingredient of the aerosols to be detected by the potentiometric sensor 131 may include nicotine or the pH concentration (the hydrogen ion concentration) of the droplets included in the aerosols.

According to the aerosol generating device 1 with reference to the embodiments described above, the signal is generated as the electric potential difference of the potentiometric sensor 131 changes due to the change in the ingredients of the aerosol. Accordingly, the change in the ingredients of the aerosols generated in the aerosol generating device 1 may be precisely and rapidly detected.

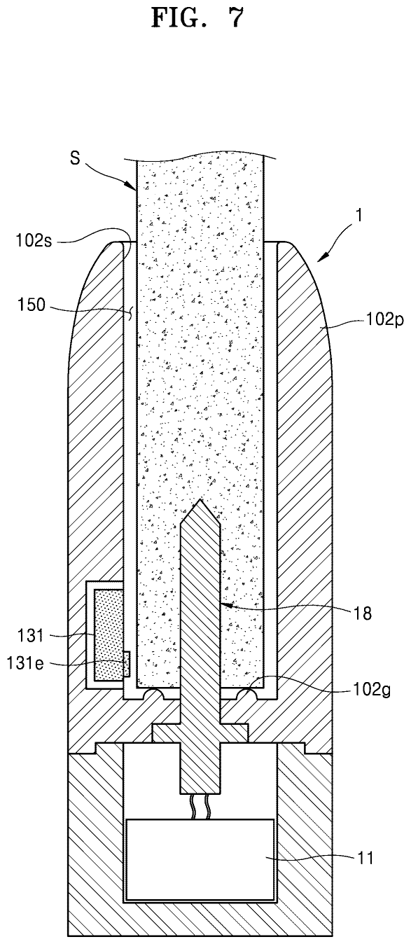

FIG. 7 is a cross-sectional view of the aerosol generating device 1 according to another embodiment.

The aerosol generating device 1 with reference to the embodiment in FIG. 7 includes an aerosol generator, a path 150, and the potentiometric sensor 131 arranged on the path 150 and configured to generate a signal based on an electric potential difference that changes according to changes in components of the aerosols generated in the aerosol generator. Air may be supplied to the aerosol generator through the path 150.

The aerosol generator includes the accommodating portion 102p, which includes an accommodating space for accommodating the stick, and the heater 18 at least partially located in the accommodating portion 102p and configured to generate heat for heating the stick S. The aerosol generating device 1 may include the power source 11 configured to supply power to the heater 18.

As illustrated in FIG. 7, when the stick S is inserted into the accommodating portion 102p, a portion of the heater 18 may be inserted into an end portion of the stick S. Bumps 102g protruding toward the end portion of the stick S are formed on a bottom surface of the accommodating space in the accommodating portion 102p. The bumps 102g may support the end portion of the stick S inserted into the accommodating portion 102p.

In addition, air introduced from the outside into the accommodating portion 102p may be supplied to the end portion of the stick S through a space between the bumps 102g. As the bumps 102g are arranged apart from each other, the air introduced into the accommodating portion 102p may pass through the space between the bumps 102g and then be supplied to the end portion of the stick S.

The path 150 may be formed by a space between the inner surface 102s of the accommodating portion 102p and an external surface of the stick S. An end of the path 150 is open toward the outside of the aerosol generating device 1, and the other end of the main path 150 is open toward the end portion of the stick S into which the heater 18 is inserted. The path 150 may extend in a direction in which the aerosol generating device 1 extends. Accordingly, the air introduced from the outside into the accommodating portion 102p may be supplied to the end portion of the stick S through the path 150.

The potentiometric sensor 131 may be arranged adjacent to the other end of the path 150 open toward the end portion of the stick S. The electrode 131e of the potentiometric sensor 131 may protrude toward the path 150. The potentiometric sensor 131 may be configured to detect the change in the ingredients of the aerosols generated from the stick S. As the electric potential difference of the potentiometric sensor 131 changes due to the change in the ingredients of the aerosols generated from the stick S heated by the stick 182, the potentiometric sensor 131 may generate a signal.

The embodiments are not limited to a position at which the potentiometric sensor 131 is arranged. For example, the potentiometric sensor 131 may be located on the bottom surface of the accommodating space in the accommodating portion 102p. As another example, the potentiometric sensor 131 may be located in the space between the bumps 102g.

According to the aerosol generating device 1 with reference to the embodiments described above, the signal is generated as the electric potential difference of the potentiometric sensor 131 changes due to the change in the ingredients of the aerosols. Accordingly, the change in the ingredients of the aerosols generated in the aerosol generating device 1 may be precisely and rapidly detected.

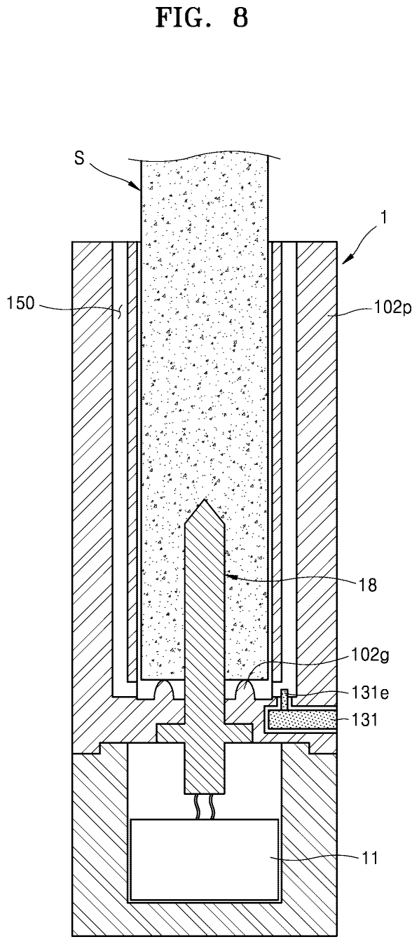

FIG. 8 is a cross-sectional view of the aerosol generating device 1 according to another embodiment.

The aerosol generating device 1 with reference to the embodiment in FIG. 8 has a configuration that is generally similar to a configuration of the aerosol generating device 1 with reference to the embodiment in FIG. 7, only with a change in a structure of the path 150.

In the aerosol generating device 1 with reference to the embodiment in FIG. 8, the path 150 is arranged in the accommodating portion 102p. In a state where the stick S is inserted into the accommodating portion 102, the inner surface of the accommodating portion 102p may support an external surface of the stick S inserted into the accommodating portion 102p. There is no space between the inner surface of the accommodating portion 102p and the stick S. Accordingly, unlike in the aerosol generating device 1 with reference to the embodiment in FIG. 7, the air does not flow through the space between the inner surface of the accommodating portion 102p and the stick S.

The path 150 is arranged in the accommodating portion 102p and extends in the direction in which the aerosol generating device 1 extends. An end of the path 150 is open toward the outside of the aerosol generating device 1, and the other end of the path 150 is open toward the end portion of the stick S into which the heater 18 is inserted. Accordingly, the air outside the aerosol generating device 1 may be supplied to the end portion of the stick S through the path 150.

The accommodating portion 102p may be manufactured, for example, through an injection molding process in which a resin or a melted metal is injected into a mold and then cured. In the injection molding process, the path 150 may be formed based on a shape of a path provided in advance in the mold. As another example, to form the path 150 in the accommodating portion 102p, a method of preparing the accommodating portion 102p and then forming the path 150 by boring the accommodating portion 102p may be used.

The potentiometric sensor 131 may be arranged adjacent to the other end of the path 150 open toward the end portion of the stick S. The electrode 131e of the potentiometric sensor 131 may protrude toward the path 150. The potentiometric sensor 131 may be configured to detect the change in the ingredients of the aerosols generated from the stick S. As the electric potential difference of the potentiometric sensor 131 changes due to the change in the ingredients of the aerosols generated from the stick S heated by the heater 18, the potentiometric sensor 131 may generate a signal.

The embodiments are not limited to a position at which the potentiometric sensor 131 is arranged. For example, the potentiometric sensor 131 may be located on the bottom surface of the accommodating space in the accommodating portion 102p. As another example, the potentiometric sensor 131 may be located in the space between the bumps 102g.

According to the aerosol generating device 1 with reference to the embodiments described above, the signal is generated as the electric potential difference of the potentiometric sensor 131 changes due to the change in the ingredients of the aerosols. Accordingly, the change in the ingredients of the aerosols generated in the aerosol generating device 1 may be precisely and rapidly detected.

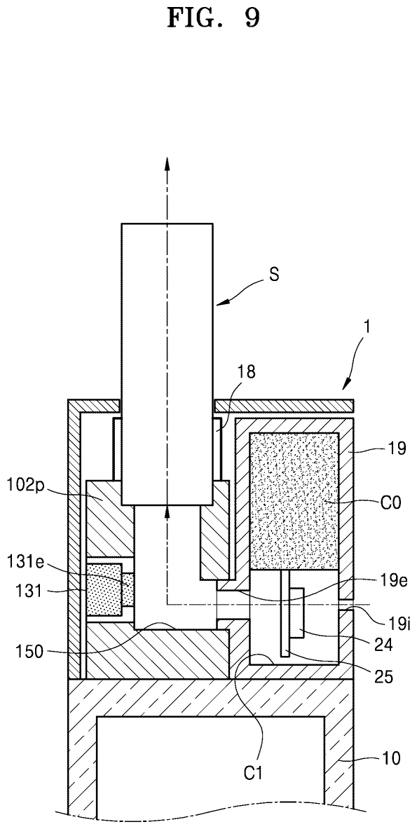

FIG. 9 is a cross-sectional view of the aerosol generating device 1 according to another embodiment.

The aerosol generating device 1 according to the embodiment in FIG. 9 includes an aerosol generator and the potentiometric sensor 131 configured to generate a signal based on an electric potential difference that changes according to changes in components of the aerosols generated in the aerosol generator.

The aerosol generator includes the accommodating portion 102p, which includes the accommodating space for accommodating the stick S, and the heater 18 at least partially supported by the accommodating portion 102p and configured to generate heat for heating the stick S.

The accommodating portion 102p may include the path 150. The path 150 may be formed so as to penetrate the accommodating portion 102p.

The cartridge 19 may be coupled to a side of the accommodating portion 102p accommodating the stick S. The cartridge 19 is another example of an aerosol generator. The cartridge 19 may be detachably mounted on the housing 10. When the cartridge 19 is mounted on the housing 10, an outlet 19e of the cartridge 19 is connected to the path 150 in the accommodating portion 102p.

An end of the path 150 is open toward the stick S. The other end of the path 150 is connected to the outlet 19e of the cartridge 19. Accordingly, air and/or aerosols delivered through the outlet 19e of the cartridge 19 may be supplied to the stick S through the path 150. For example, when the aerosol generating device 1 operates to only heat the stick S in a state where an operation of the cartridge 19 stops, the air may be supplied from the cartridge 19 to the main path 150.

The cartridge 19 may include the chamber C0 therein. The chamber C0 may store the aerosol generating material in any one of various states, e.g., a liquid state, a solid state, a gas state, a gel state, or the like.

In a state where the cartridge 19 is inserted into the housing 10, external air may be introduced into the housing 10. The external air may be introduced into the aerosol generating chamber C1 in the cartridge 19 through an inlet 19i of the cartridge 19.

The cartridge 19 may include the cartridge heater 24 configured to heat the aerosol generating material in the chamber C0 containing the aerosol generating material. The liquid delivery element 25 impregnated with (containing) the aerosol generating material may be arranged in the chamber C0.

The cartridge 19 may be configured to generate the aerosols. The aerosols may be generated as the liquid delivery element 25 is heated by the cartridge heater 24. The aerosols generated in the aerosol generating chamber C1 in the cartridge 19 may be delivered to the stick through the outlet 19e and the path 150.

According to the aerosol generating device 1 with reference to the embodiments described above, as the user performs an inhalation operation, the aerosols generated in the cartridge 19 may pass through the path 150 and then be supplied to the user.

The potentiometric sensor 131 is arranged in the accommodating portion 102p. The electrode 131e of the potentiometric sensor 131 may be exposed toward the path 150 of the accommodating portion 102p. An arrangement structure of the electrode 131e of the potentiometric sensor 131 may be modified. For example, at least a portion of the electrode 131e of the potentiometric sensor 131 may protrude toward an inner portion of the path 150.

The embodiments are not limited to an arrangement position of the potentiometric sensor 131 illustrated in FIG. 9. For example, the potentiometric sensor 131 may be arranged in the cartridge 19. That is, by modifying the structure illustrated in FIG. 9, the potentiometric sensor 131 may be arranged in the outlet 19e and/or the inlet 19i.

As another example, the potentiometric sensor 131 may be arranged in all or some of the accommodating portion 102p, the outlet 19e, and the inlet 19i.

The potentiometric sensor 131 may be configured to detect the change in the ingredients of the aerosols generated from the stick S and/or the aerosols generated in the cartridge 19. The potentiometric sensor 131 may be configured to generate a signal as an electric potential difference of the potentiometric sensor 131 changes due to the change in the ingredients of the aerosols generated from the stick S heated by the heater 18 and/or the aerosols generated in the cartridge 19.

According to the aerosol generating device 1 with reference to the embodiments described above, the signal is generated as the electric potential difference of the potentiometric sensor 131 changes due to the change in the ingredients of the aerosols. Accordingly, the change in the ingredients of the aerosols generated in the aerosol generating device 1 may be precisely and rapidly detected.

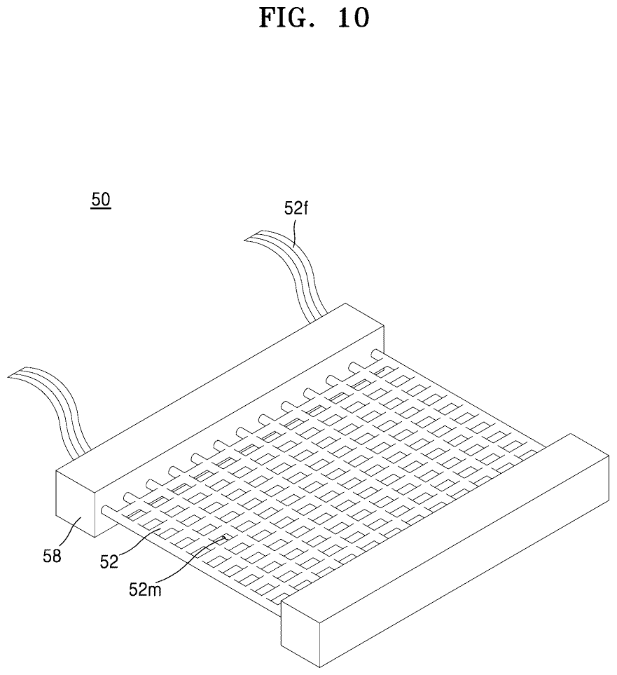

FIG. 10 is a perspective view of a potentiometric sensor 50 applicable to the aerosol generating device 1 with reference to the embodiments illustrated in FIGS. 1 to 9. FIG. 10 schematically illustrates a structure of the potentiometric sensor 50 that may be arranged in a path of the aerosol generating device.

At least a portion of the potentiometric sensor 50 may be in the path of the aerosol generating device. Aerosols generated in the aerosol generator may flow through the path.

The potentiometric sensor 50 may be configured to perform a function of being in contact with the aerosols and liquefying a portion of the aerosols and a function of being in contact with generated droplets and generating a signal. To generate the droplets, a surface of the potentiometric sensor 50 may be maintained at a temperature lower than a temperature of the aerosols. For example, at least a portion of the potentiometric sensor 50 may be connected to a thermally conductive material exposed toward the outside of the aerosol generating device, and due to the thermally conductive material being in contact with external air, the potentiometric sensor 50 may be maintained at the temperature lower than the temperature of the aerosols.

The potentiometric sensor 50 includes a signal generator 52 configured to generate signals. The signal generator 52 may include a mesh material through which the aerosols in the gas state may flow. The mesh material may have a net shape with fine pores 52m through which the aerosols may pass. For example, the signal generator 52 may include a metal mesh material. The signal generator 52 may be supported by a frame 58. A wiring 52f for delivering an electric signal is electrically connected to the signal generator 52.

The aerosols flowing through the path may pass through the fine pores 52m of the signal generator 52. In a process where the aerosols pass through the fine pores 52m of the signal generator 52, droplets are generated due to liquefaction of some of the aerosols. The droplets generated due the liquefaction of the aerosols are attached to a surface of the signal generator 52.

Ingredients of the droplets generated from the aerosols change due to a change in the ingredients included in the aerosols. The potentiometric sensor 50 may be configured to detect the change in the ingredients of the droplets. When the droplets are attached to the signal generator 52, an electric potential difference of the signal generator 52 occurs, and thus, the signal of the potentiometric sensor 520 is generated. For example, the signal of the potentiometric sensor 50 may be generated due to a change in the electric potential difference of the signal generator 52 according to a pH concentration of the droplets.

The signal generator 52 may include, for example, a reference electrode and a measuring electrode.

For example, the reference electrode and the measuring electrode may be manufactured by using any one of a sensing material such as silver chloride or potassium chloride, a glass electrode, indium tin oxide (ITO), or an Ion Sensitive Field Effect Transistor (ISFET), or a combination thereof.

In addition, the signal generator 52 may further include a protective material or a coating material manufactured by using any one of polycarbonate (PC), polyimide (PI), polyetherimide, or polytetrafluoroethylene (PTFE), or a combination thereof.

The change in the ingredients of the droplets being in contact with the signal generator 52 may cause an electric potential difference of an electric signal between the reference electrode and the measuring electrode. The signal generator 52 may be configured to generate a signal due to a change in the electric potential difference between the reference electrode and the measuring electrode. A pH concentration of the droplets contained in the aerosols may be detected based on the signal of the signal generator 52.

The potentiometric sensor 50 may further include a cleaning device configured to remove the droplets and/or foreign substances attached to the potentiometric sensor 50. When an aerosol generation operation by the aerosol generating device and/or an inhalation operation by the user ends, the cleaning device may remove the droplets and/or the foreign substances of the potentiometric sensor 50.

For example, the cleaning device may be implemented by a piezoelectric actuator or an electric motor embedded in the frame 58 or connected to the frame 58.

Electricity may be supplied to the cleaning device through the wiring 52f connected to the frame 58. An electric signal applied to the cleaning device causes vibration of the piezoelectric actuator or the motor, and the vibration is delivered to the signal generator 52. When the signal generator 52 vibrates, the droplets and/or the foreign substances attached to the signal generator 52 may be separated from the signal generator 52.

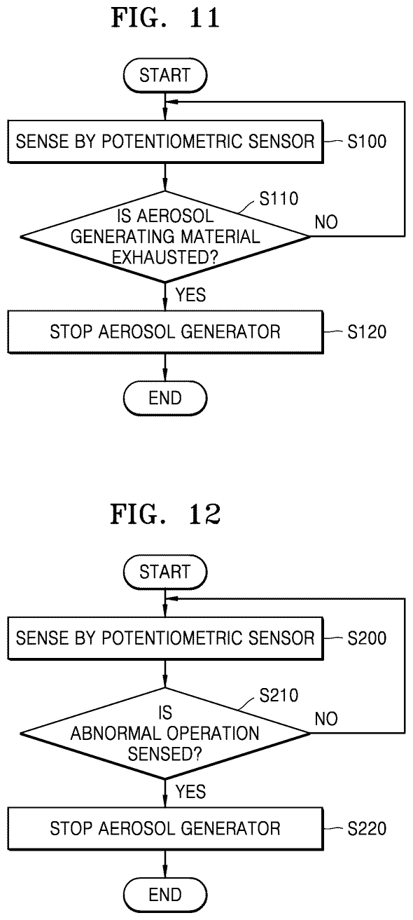

FIG. 11 is a flowchart illustrating an example of an operation of an aerosol generating device with reference to various embodiments.

The operation of the aerosol generating device illustrated in FIG. 11 may be used to correspond to, for example a state where the aerosol generating material contained in the aerosol generating article and a medium or the aerosol generating material in the cartridge are exhausted and the aerosol generation operation is not well performed.

An example of the operation of the aerosol generating device includes a sensing operation S100 by using a potentiometric sensor to detect a change in the ingredients of the aerosols during an operation of the aerosol generating device.

In the sensing operation S100 in which the potentiometric sensor is used, the potentiometric sensor may generate a signal as an electric potential difference of the potentiometric sensor is generated due to a change in the ingredients of the aerosols and/or the droplets being in contact with the potentiometric sensor. For example, the potentiometric sensor may detect a pH concentration of the droplets generated from the aerosols by measuring a change in the electric potential difference.

After the sensing operation S100 in which the potentiometric sensor is used, an operation S110 of sensing exhaustion of the aerosol generating material based on the signal of the potentiometric sensor may be performed. In the operation S110 of sensing the exhaustion of the aerosol generating material, the exhaustion of the aerosol generating material may be sensed based on a preset change in the ingredients of the aerosols regarding the exhaustion of the aerosol generating material. For example, based on a result of the sensing by the potentiometric sensor, when nicotine in the aerosols or a pH concentration of the droplets included in the aerosols decreases to be less than a preset reference value, it may be determined that the aerosol generating material is exhausted.

When the exhaustion of the aerosol generating material is sensed in the operation S110 of sensing exhaustion of the aerosol generating material, an operation S120 of stopping the aerosol generator of the aerosol generating device may be performed. According to the operation S120 of stopping the aerosol generator, as an operation of the aerosol generator generating the aerosols stops, generation of the aerosols may stop.

After the operation S120 of stopping the aerosol generator, or simultaneously with the operation S120 of stopping the aerosol generator, an operation of notifying the user with the exhaustion of the aerosol generating material may be performed. The operation of notifying the user with the exhaustion of the aerosol generating material may be performed by, for example, displaying information on a display device, turning on a display lamp, outputting a sound signal, or outputting vibration feedbacks.

Through the operations of the aerosol generating device with reference to the embodiments described above, a situation in which the aerosol generating device is exhausted may be rapidly and precisely sensed even without mounting an expensive sensor for detecting an amount of the aerosol generating material on the aerosol generating device, and based on a result of the sensing, the operation of the aerosol generating device may be efficiently controlled.

FIG. 12 is a flowchart of another example of an operation of an aerosol generating device with reference to various embodiments.

The operation of the aerosol generating device illustrate in FIG. 12 may be used for sensing a situation in which the aerosol generating device is in an abnormal operation. The abnormal operation of the aerosol generating device may include, for example, overheating of the heater, a dry puff in which a heating operation by the heater is performed in a state where the aerosol generating material of the cartridge is exhausted, abnormal heating in which a heating temperature by the heater fails to reach a preset reference temperature in an environment with an excessive low temperature, use of an aerosol generating article not allowed to be used in the aerosol generating device, reuse of the aerosol generating article that has been already used for generating the aerosols, and/or use of inappropriate articles including an aerosol generating material not allowed for the aerosol generating device.

Another example of the operation of the aerosol generating device includes a sensing operation S200 by using a potentiometric sensor to detect a change in the ingredients of the aerosols while the aerosol generating device operates.

In the sensing operation S200 in which the potentiometric sensor is used, the potentiometric sensor may generate a signal as an electric potential difference of the potentiometric sensor is generated due to a change in the ingredients of the aerosols and/or the droplets being in contact with the potentiometric sensor. For example, the potentiometric sensor may detect the pH concentration of the droplets generated from the aerosols by measuring the change in the electric potential difference.

After the sensing operation S200 in which the potentiometric sensor is used, an operation S210 of sensing performance of an abnormal operation of the aerosol generating device based on the signal of the potentiometric sensor may be performed.

In the operation S210 of sensing the performance of the abnormal operations of the aerosol generating device, the performance of the abnormal operations may be sensed based on a preset change in the ingredients of the aerosols with reference to the abnormal operations. For example, based on a result of the sensing by the potentiometric sensor, when nicotine in the aerosols or the pH concentration of the droplets included in the aerosols exceeds a preset range, it may be determined that the abnormal operations are performed.

When the performance of the abnormal operations by the aerosol generating device is sensed in the operation S210 of sensing the performance of the abnormal operations by the aerosol generating device, an operation S220 of stopping the aerosol generator of the aerosol generating device may be performed. According to the operation S220 of stopping the aerosol generating device, as the operation of the aerosol generator stops, generation of the aerosols may stop.

After the operation S220 of stopping the aerosol generator, or simultaneously with the operation S220 of stopping the aerosol generator, an operation of notifying the user with occurrence of the abnormal operations may be performed. The operation of notifying the user with the occurrence of the abnormal operations may be performed by, for example, displaying information for guiding ‘use of allowed articles’ on a display device, turning on a display lamp, outputting a voice guide for guiding ‘use of allowed articles’, or outputting vibration feedbacks.

According to the operations by the aerosol generating device with reference to embodiments described above, situations of various abnormal operations by the aerosol generating device may be rapidly and precisely detected by using the potentiometric sensor.

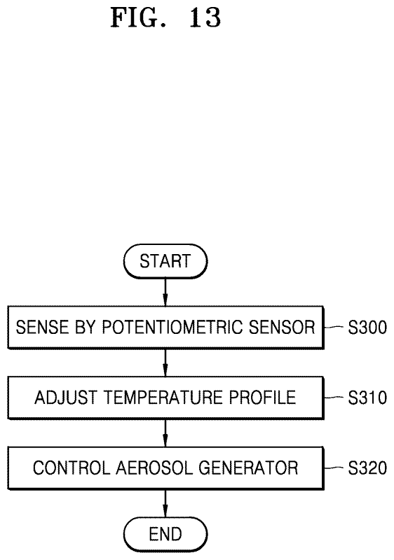

FIG. 13 is a flowchart illustrating another example of an operation of the aerosol generating device with reference to various embodiment.

The operation of the aerosol generating device illustrated in FIG. 13 may be related to, e.g., an operation of adjusting a temperature profile of the aerosol generator in correspondence to a type of the aerosol generating material mounted on the aerosol generating device or a type of a medium of the cartridge or the aerosol generating material. As another example, the operation of the aerosol generating device may be related to an operation of adjusting the temperature profile of the aerosol generator in accordance with progress of an inhalation time during which an operation of inhaling the aerosols is performed.

The operation of the aerosol generator includes an operation S300 of sensing by using the potentiometric sensor to detect a change in the ingredients of the aerosols while the aerosol generating device operates.

In the operation of sensing S300 in which the potentiometric sensor is used, the potentiometric sensor may generate a signal as an electric potential difference of the potentiometric sensor is generated due to a change in the ingredients of the aerosols and/or droplets being in contact with the potentiometric sensor. For example, the potentiometric sensor may detect a pH concentration of the droplets generated from the aerosols by measuring a change in the electric potential difference.

After the operation of sensing S300 in which the potentiometric sensor is used, an operation S310 of adjusting temperature profiles may be performed. In the operation S310 of adjusting the temperature profiles, the temperature profiles related to various parameters for controlling the aerosol generators may be generated, based on a result of the sensing in the operation S300 of sensing by using the potentiometric sensor.

In the operation S310 of adjusting the temperature profiles, for example, the type of the aerosol generating article mounted in the aerosol generating device or the type of the medium or the aerosol generating material in the cartridge may be determined based on the result of sensing by the potentiometric sensor, and temperature profiles appropriate for a determined type of the aerosol generating article and the like may be selected.

As another example, in the operation S310 of adjusting the temperature profiles, a change in nicotine of the aerosol or the pH concentration of the droplets contained in the aerosols may be sensed by the potentiometric sensor, and a progress time in which the inhalation operation is performed or the number of times of inhalation operation may be estimated. In the operation S310 of adjusting the temperature profiles, the temperature profile related to the operation of the aerosol generator may be adjusted in consideration of the progress time of the inhalation operation or the number of times of inhalation operation estimated based on the result of sensing by the potentiometric sensor.

After the operation S310 of adjusting the temperature profile, an operation S320 of controlling the operation of the aerosol generator by using the adjusted temperature profile may be performed.

According to the operations of the aerosol generating device with reference to the embodiments described above, the operations of the aerosol generator may be controlled by immediately detecting the change in the ingredients of the aerosols and reflecting the change in the ingredients of the aerosols, an operation of generating the aerosols may be efficiently implemented.

According to an aerosol generating device with reference to the embodiments, a signal of a potentiometric signal is generated as an electric potential difference of the potentiometric sensor changes due to a change in ingredients of aerosols. Accordingly, the change in the ingredients of the aerosols generated in the aerosol generating device may be precisely and rapidly detected.

According to an operation of an aerosol generating device with reference to embodiments, a situation in which an aerosol generating material is exhausted may be rapidly and precisely detected even without mounting an expensive sensor for detecting an amount of the aerosol generating material on the aerosol generating device. In addition, based on a result of sensing by using a potentiometric sensor, the operation of the aerosol generating device may be efficiently controlled.

According to an operation of an aerosol generating device with reference to embodiments, it is possible to rapidly and precisely cope with situations of various types of abnormal operations of the aerosol generating device, by using a potentiometric sensor.

According to an operation of an aerosol generating device with reference to the embodiments described above, as an operation of an aerosol generator may be controlled by immediately reflecting a change in ingredients of aerosols, an operation of generating aerosols may be efficiently implemented.

The effects of the embodiments are not limited to the effects described above, and effects that are not mentioned may be clearly understood by those of ordinary skill in the art, to which the embodiments belong, from the present specification and the attached drawings.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as limiting in all respects, but should be considered as illustrative. The scope of the present disclosure should be determined by a reasonable interpretation of the appended claims, and all changes within the equivalent scope of the present disclosure are included in the scope of the present disclosure.

What is claimed is:

1. An aerosol generating device comprising:
an aerosol generator configured to generate aerosols; and
a potentiometric sensor configured to generate a signal based on an electric potential difference that changes according to changes in components of the aerosols generated by the aerosol generator.

2. The aerosol generating device of claim 1, further comprising
a path through which at least a portion of the aerosols generated in the aerosol generator flows, and the potentiometric sensor is configured to generate the signal, based on changes in components of the aerosols flowing through the path.

3. The aerosol generating device of claim 2, wherein at least a portion of the potentiometric sensor is located on the path.

4. The aerosol generating device of claim 1, wherein the potentiometric sensor is configured to generate the signal, based on a pH change in the aerosols.

5. The aerosol generating device of claim 2, wherein
the aerosol generator comprises an aerosol generating chamber for generating the aerosols, the path is connected to the aerosol generating chamber, the aerosols generated in the aerosol generating chamber flow through the path, and
the potentiometric sensor generates the signal, based on changes in components of the aerosols flowing through the path.

6. The aerosol generating device of claim 2, wherein
the aerosol generator comprises: an accommodating portion for accommodating an aerosol generating article for generating aerosols; and a heater configured to heat the aerosol generating article, and
the path is formed by a space between the aerosol generating article accommodated in the accommodating portion and an inner surface of the accommodating portion.

7. The aerosol generating device of claim 2, wherein
the aerosol generator comprises: an accommodating portion for accommodating an aerosol generating article for generating aerosols; and a heater configured to heat the aerosol generating article, and
the path passes through the accommodating portion.

8. The aerosol generating device of claim 1, wherein
the aerosol generator comprises:
a cartridge configured to generate aerosols from an aerosol generating article; and
an accommodating portion accommodating the aerosol generating article and configured to deliver the aerosols generated in the cartridge to the aerosol generating article, and
the potentiometric sensor is arranged in the accommodating portion.

9. The aerosol generating device of claim 8, wherein
the aerosol generator further comprises a heater configured to generate aerosols by heating the aerosol generating article accommodated in the accommodating portion, and
the potentiometric sensor is configured to generate a signal based on an electric potential difference that changes according to changes in components of at least one of the aerosols generated from the aerosol generating article and the aerosols generated in the cartridge.

10. The aerosol generating device of claim 1, further comprising
a controller configured to control operation of the aerosol generator,
the aerosol generator is configured to generate aerosols from an aerosol generating material, and
the controller is configured to detect exhaustion of the aerosol generating material, based on the signal of the potentiometric sensor, and stop operation of the aerosol generator when the aerosol generating material is exhausted.

11. The aerosol generating device of claim 1, further comprising
a controller configured to control operation of the aerosol generator,
wherein the controller is configured to sense abnormal operation of the aerosol generator, based on the signal of the potentiometric sensor, and stop the operation of the aerosol generator when the aerosol generator is in the abnormal operation.

12. The aerosol generating device of claim 1, wherein
the aerosol generator comprises a heater configured to generate aerosols, and
the aerosol generating device further comprises a controller configured to control operation of the heater, based on a preset temperature profile, and
the controller is configured to change the temperature profile to control the operation of the heater, based on the signal of the potentiometric sensor.

13. The aerosol generating device of claim 1, wherein
the potentiometric sensor comprises a signal generator formed of a mesh material through which aerosols pass, droplets are generated when aerosols pass through the signal generator, and the signal generator is configured to generate the signal based on changes in the electric potential difference according to changes in components of the droplets.

14. The aerosol generating device of claim 1, wherein
the potentiometric sensor comes into contact with the aerosols and liquefies a portion of the aerosols, and the potentiometric sensor generates the signal upon contact with droplets generated from the aerosols.

15. The aerosol generating device of claim 1, wherein
the potentiometric sensor comprises a reference electrode and a measuring electrode, and the signal is generated in accordance with changes in an electric potential difference between the reference electrode and the measuring electrode according to changes in components of the aerosols.
